(19) United States
(12) Patent Application Publication
(10) Pub. No.: US 2008/0032117 A1
(43) Pub. Date: Feb. 7, 2008

(54) Aqueous/Organic Metal Oxide Dispersion And Coated Substrates And Mouldings Produced Therewith

(75) Inventors: Yi Deng, Hanau (DE); Monika Oswald, Hanau (DE); Klaus Deller, Hainburg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa AG, Duesseldorf (DE)

(21) Appl. No.: 11/629,487

(22) PCT Filed: Jun. 11, 2005
(86) PCT No.: PCT/EP05/06275

§ 371 Date: Dec. 14, 2006

(30) Foreign Application Priority Data
Jun. 22, 2004 (DE) 10 2004 030 104.2

(51) Int. Cl. C23C 18/12; C03C 17/25

(52) U.S. Cl. 428/332; 427/383.1; 516/88; 516/89; 516/90; 516/92; 516/93

(57) ABSTRACT

A binder-free metal oxide dispersion with a content of metal oxide of greater than 15 wt. %, wherein the metal oxide powder in the dispersion has a number-average aggregate diameter of less than 200 nm and the dispersion comprises as the liquid phase a mixture of water and a water-miscible, organic solvent. Coated substrates and mouldings produced with the metal oxide dispersion.

The invention relates to a metal oxide dispersion, which contains a metal oxide powder, water and a water-miscible, organic solvent, and to a coated substrate and a moulding produced therewith.

It is known to produce metal oxide layers, in particular silicon dioxide layers, by the sol-gel process. Silicon alkoxides are here partially or completely hydrolysed by the addition of water in the presence of a catalyst. The sols obtained in this manner are used for coating, for example by the dip coating or spin coating methods. The production process for sols is complex. It generally involves the production of a sol by hydrolysis of a metal alkoxide, a subsequent gelation step, which, depending on the chemical composition of the sol, may last from a few seconds to a few days. If gelation does not proceed too rapidly, it is possible to apply a layer onto a substrate from the sol. The layers produced in this manner are thin, in general at most a few hundred nanometres.

Repeated coating operations are necessary if thicker layers are to be produced. On subsequent drying and sintering, layers produced in this manner often have a tendency to crack and give rise to irregular layer thicknesses. It should be noted that such a sol obtained by hydrolysis of metal alkoxides is a complex “living” system, the behaviour of which critically depends on temperature, humidity, alcohol content and other variables and is difficult to control and reproduce.

WO 00/14013 describes a process in which a very finely divided, pyrogenically produced silicon dioxide powder is added to a sol which has been produced as described above.

In this manner, the filler content of the sol may be increased and layers of a thickness of several micrometres may be produced in a single coating operation. A problematic feature of this process is the incorporation of the finely divided pyrogenically produced silicon dioxide powder.

Pyrogenically produced metal oxide powders are generally understood to be those which are obtained by flame hydrolysis or flame oxidation from a metal oxide precursor in a detonating gas flame. In this process, approximately spherical primary particles are initially obtained which sinter together to form aggregates over the course of the reaction. The aggregates may then combine to form agglomerates. Unlike agglomerates, which may in general readily be broken down into aggregates by input of energy, aggregates can only be further broken down, if at all, by intensive input of energy.

If such a pyrogenically produced metal oxide powder is then introduced into a sol by means of stirring energy, there is a risk of premature gelation. Moreover, it is difficult to disperse the introduced powder uniformly in the sol, which may result in non-uniform layers.

Another prior art approach is to improve the application of a dispersion by addition of binders. The disadvantage in this case is that it is generally difficult to achieve complete removal of the binder in a sintering step. Discoloration and cracking may be the result.

The object of the invention is to provide a dispersion which is suitable for the application of layers and avoids the disadvantages of the prior art. The dispersion should in particular be suitable for the production of thick, crack-free, vitreous or ceramic layers. It should also be suitable for the production of mouldings which exhibit neither cracks nor non-uniformities.

It has now been found that this object is achieved by a binder-free metal oxide dispersion with a content of metal oxide of greater than 15 wt. %, wherein the metal oxide powder in the dispersion has a number-average aggregate diameter of less than 200 nm and the dispersion comprises as the liquid phase a mixture of water and a water-miscible, organic solvent.

In order to obtain layers and mouldings of high quality, it is necessary for the number-average aggregate diameter of the metal oxide particles in the dispersion to be less than 200 nm. Coarser aggregates give rise to non-uniform coatings and cracks in the coating. The metal oxide powder in the dispersion advantageously exhibits a number-average aggregate diameter of less than 100 nm. Dispersions with particles of such a small size may be produced by special dispersion methods. Suitable dispersion apparatuses may be, for example, rotor-stator machines or planetary kneaders, wherein, especially for aggregate diameters of less than 100 nm, high-energy mills may be particularly preferred. In these apparatuses, two pressurised, predispersed streams of dispersion are depressurised through a nozzle. The two dispersion jets collide exactly with one another and the particles grind one another. In another embodiment, the predispersion is likewise raised to an elevated pressure, but the particles collide against armoured areas of wall. The operation can be repeated as often as desired in order to obtain smaller particle sizes.

The dispersion according to the invention may be obtained here by initially producing a metal oxide dispersion in water, preferably using a high-energy mill, and then adding thereto the organic solvent with input of a low level of energy, for instance by stirring. It is also possible initially to introduce water and organic solvent in the desired ratio right from the outset and to grind the metal oxide powder by means of a high-energy mill.

The content of metal oxide powder in the dispersion according to the invention amounts in a preferred embodiment to 10 to 50 wt. %, relative to the total quantity of dispersion.

The origin of the metal oxide powder used is not a critical factor for the dispersion according to the invention. It has, however, been found that pyrogenically produced metal oxide powders may advantageously be used. The production of silicon dioxide by flame hydrolysis of silicon tetrachloride may be mentioned by way of example. Mixed oxides may also be obtained in pyrogenic processes by joint flame hydrolysis or flame oxidation.

SiO₂, Al₂O₃, TiO₂, CeO₂, ZrO₂, In₂O₃, SnO, or a mixed oxide of the stated metals are particularly preferred. Mixed oxides here also comprise doped metal oxides, such as for example silver-doped silicon dioxide.

The pyrogenic metal oxide powder advantageously exhibits a BET surface area of 30 to 200 m²/g.

Selection of the organic solvent in the dispersion according to the invention is not critical, provided that it is water-miscible. The dispersion according to the invention may preferably contain methanol, ethanol, n-propanol, iso-propanol, n-butanol, glycol, tert.-butanol, 2-propanone, 2-butanone, diethyl ether, tert.-butyl methyl ether, tetrahydrofuran and/or ethyl acetate.

The ratio of organic solvent to water in the dispersion according to the invention is primarily determined by the metal oxide and the desired content thereof in the dispersion. It has been found that a ratio by volume of organic solvent to water of between 0.5 and 5 gives rise to coatings and mouldings of elevated quality.

The dispersion according to the invention may furthermore contain substances with an acid action, substances with a basic action and/or salts, in each case in dissolved form.

A particularly preferred dispersion is one which exhibits the following features:
the metal oxide powder is a pyrogenically produced titanium dioxide with a BET surface area of between 40 and 120 m²/g,
the content of titanium dioxide, relative to the whole dispersion, is at least 15 wt. %,
the number-average aggregate diameter in the dispersion is less than 100 nm,
the organic solvent is ethanol,
the ratio by volume of ethanol to water is between 0.5 and 2.5, and
the pH value is between 2.5 and 9.

The invention furthermore provides a substrate coated with the dispersion according to the invention.

The process for the production of the coated substrate comprises the application of the dispersion onto the substrate by dip coating, brush application, spraying or knife coating, followed by drying of the layer adhering to the substrate and subsequent sintering.

Suitable substrates may be metal or alloy substrates, materials with a very low coefficient of thermal expansion (ultra-low expansion materials), borosilicate glass, silica glass, vitreous ceramics or silicon wafers.

The invention furthermore provides a moulding produced with the dispersion according to the invention.

The process for the production of the moulding comprises pouring the dispersion according to the invention into a mould, preferably of hydrophobic material, then drying at temperatures of below 100° C., optional post-drying at temperatures of 60° C. to 120° C. after removal from the mould and subsequent sintering.

### EXAMPLES

Starting dispersion D-90-0: 30 weight percent dispersion in water of a pyrogenically produced titanium dioxide powder with a BET surface area of approx. 90 m²/g, a (number-) average aggregate diameter of 87 nm and a pH value of 7.2.

Starting dispersion D-50-0: 40 weight percent dispersion in water of a pyrogenically produced titanium dioxide powder with a BET surface area of approx. 50 m²/g, a (number-) average aggregate diameter of 69 nm and a pH value of 6.2.

Dispersion D-90-1 (Comparison): 100 ml of water are stirred into 150 ml of dispersion D-90-0.

Dispersion D-50-1 (Comparison): 100 ml of water are stirred into 150 ml of dispersion D-50-0.

Dispersion D-90-2 (according to the invention): 100 ml of ethanol are stirred into 150 ml of dispersion D-90-0.

Dispersion D-50-2 (according to the invention): 100 ml of ethanol are stirred into 150 ml of dispersion D-90-0.

The number-average aggregate diameter in the samples diluted with water or ethanol is identical to the values from the starting dispersions.

Glass substrates are dip-coated with the water- or ethanol-diluted dispersions, then dried at temperatures of below 100° C. and subsequently heat treated at temperatures of approx. 500° C.

The quality of the layers with regard to cracks, surface uniformity and layer thickness was analysed by light microscopy and scanning electron microscopy (SEM).

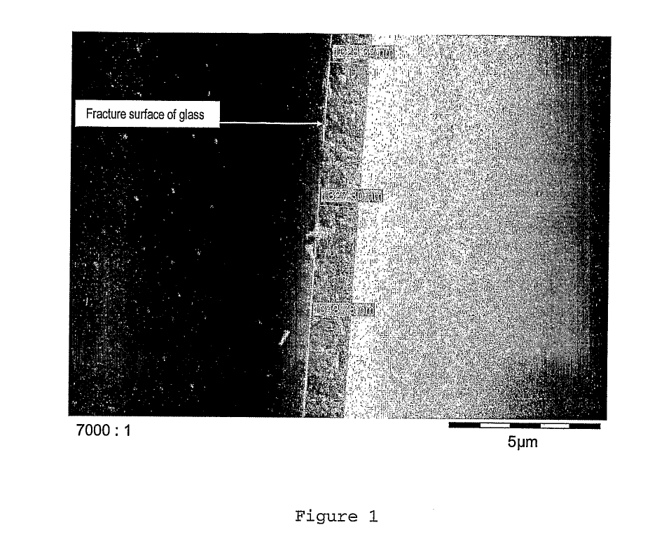

This revealed that the layers produced with the starting dispersions became partially detached merely after drying. While the water-diluted dispersions did indeed yield crack-free layers, layer thickness was not uniform (gradient). The layers produced from the ethanol-diluted dispersions, in contrast, yielded crack-free layers of uniform thickness. FIG. 1 shows an SEM micrograph of glass coated with dispersion D-90-2 with a uniform layer thickness.

1. A binder-free metal oxide dispersion with a content of metal oxide of greater than 15 wt. %, wherein the metal oxide powder in the dispersion has a number-average aggregate diameter of less than 200 nm and the dispersion comprises as the liquid phase a mixture of water and a water-miscible, organic solvent.

2. A binder-free metal oxide dispersion according to claim 1, characterised in that the average secondary particle size is less than 100 nm.

3. A binder-free metal oxide dispersion according to claim 1, characterised in that the content of metal oxide powder is 10 to 50 wt. %.

4. A binder-free metal oxide dispersion according to claim 1, characterised in that the metal oxide powder is pyrogenically produced.

5. A binder-free metal oxide dispersion according to claim 4, characterised in that the pyrogenically produced metal oxide powder is SiO₂, Al₂O₃, TiO₂, CeO₂, ZrO₂, In₂O₃, SnO, SbO or a mixed oxide of the stated metals.

6. A binder-free metal oxide dispersion according to claim 4, characterised in that the pyrogenically produced metal oxide powder exhibits a BET surface area of 30 to 200 m²/g.

7. A binder-free metal oxide dispersion according to claim 1, characterised in that the organic solvent is methanol, ethanol, n-propanol, iso-propanol, n-butanol, glycol, tert-butanol, 2-propanone, 2-butanone, diethyl ether, tert-butyl methyl ether, tetrahydrofuran and/or ethyl acetate.

8. A binder-free metal oxide dispersion according to claim 1, characterised in that the ratio by volume of organic solvent to water is between 0.5 and 5.

9. A binder-free metal oxide dispersion according to claim 1, characterised in that it contains substances with an acid action, substances with a basic action and/or salts.

10. A binder-free metal oxide dispersion according to claim 1, characterised in that
the metal oxide powder is pyrogenically produced titanium dioxide with a BET surface area of between 40 and 120 m²/g,
the content of titanium dioxide, relative to the whole dispersion, is at least 15 wt. %,
the average secondary particle size in the dispersion is less than 100 nm,
the organic solvent is ethanol,
the ratio by volume of ethanol to water is between 0.5 and 2.5, and
the pH value is between 2.5 and 9.0.

11. A substrate coated with the binder-free metal oxide dispersion according to claim 1.

12. A process for the production of the coated substrate according to claim 11 by application of the binder-free metal oxide dispersion onto the substrate by dip coating, brush application, spraying or knife coating, followed by drying of the layer adhering to the substrate and subsequent sintering, said binder-free metal oxide dispersion comprising a content of metal oxide of greater than 15 wt. %, wherein the metal oxide powder in the dispersion has a number-average aggregate diameter of less than 200 nm and the dispersion comprises as the liquid phase a mixture of water and a water-miscible, organic solvent.

13. A moulding produced with the binder-free metal oxide dispersion according to claim 1.

14. A process for the production of the moulding according to claim 13, characterised in that the binder-free metal oxide dispersion is poured into a mould, then dried at temperatures of below 100° C., optionally post-dried at temperatures of 60° C. to 120° C. after removal from the mould and subsequently sintered, said binder-free metal oxide dispersion comprising a content of metal oxide of greater than 15 wt. %, wherein the metal oxide powder in the dispersion has a number-average aggregate diameter of less than 200 nm and the dispersion comprises as the liquid phase a mixture of water and a water-miscible, organic solvent.
